(19) United States
(12) Patent Application Publication
(10) Pub. No.: US 2017/0232868 A1
(43) Pub. Date: Aug. 17, 2017

(54) OCCUPANT DETECTION METHOD AND OCCUPANT DETECTION APPARATUS

(71) Applicant: AISIN SEIKI KABUSHIKI KAISHA, Kariya-shi (JP)

(72) Inventors: Takahiro IZUNO, Kariya-shi (JP); Hiroyuki FUJII, Kariya-shi (JP); lsao HONDA, Chiryu-shi (JP)

(73) Assignee: AISIN SEIKI KABUSHIKI KAISHA, Kariya-shi (JP)

(21) Appl. No.: 15/378,865

(22) Filed: Dec. 14, 2016

(30) Foreign Application Priority Data
Feb. 15, 2016 (JP) 2016-026144

(51) Int. Cl. B60N 2/00; G01L 5/00; B60R 21/015

(52) U.S. Cl. CPC B60N 2/002; B60R 21/01524; B60R 21/01554; B60R 21/01556; G01L 5/00; B60R 2021/01286

(57) ABSTRACT

An occupant detection method includes detecting a load acting on a seat for a vehicle with use of a load sensor provided at the seat, monitoring a seating sensor output outputted from a seating sensor forming a detection region at the seat, and determining that a child occupant is seated at a child restraint seat installed at the seat when a detection value of the load sensor is equal to or larger than a minimum value determining that an adult occupant is seated at the seat and equal to or smaller than a maximum value determining that the child occupant is seated at the child restraint seat, in a case where the seating sensor output indicates a state in which a seating load of an occupant is not applied to the detection region, the seating load corresponding to a load of the occupant while the occupant is seated.

### CROSS REFERENCE TO RELATED APPLICATIONS

This application is based on and claims priority under 35 U.S.C. §119 to Japanese Patent Application 2016-26144, filed on Feb. 15, 2016, the entire content of which is incorporated herein by reference.

### TECHNICAL FIELD

This disclosure generally relates to an occupant detection method and an occupant detection apparatus.

### BACKGROUND DISCUSSION

Conventionally, an occupant detection apparatus for a vehicle may use a load sensor detecting a seat load and a seating sensor forming a detection region at a seating surface of the seat. For example, a known occupant detection apparatus described in JP2010-195358A (which will be hereinafter referred to as Patent reference 1) performs seating detection of an occupant of a seat on the basis of comparison between a detection value of a seat load detected by a load sensor and a threshold value. At the known occupant detection apparatus, a membrane switch is used as the seating sensor. By changing the threshold value of the seat load which is used for occupant detection on the basis of an on/off state of the seating sensor, the known occupant detection apparatus can perform the occupant detection accurately even in a case where a posture of the occupant seated at the seat includes deviation (positional deviation and/or leaning toward a side).

In addition, according to the above-described configuration in which the occupant detection at the vehicle is performed on the basis of the detection value of the seat load, by setting a detection threshold value, confirmation is often performed whether or not the occupant seated at the seat is an adult for whom an airbag can be inflated. Generally, in a case where the occupant of the seat cannot be determined as the adult, it is determined that the seat is empty or a child is seated, or it is determined that a child restraint seat (CRS) or a child safety seat is installed on or attached to the seat, and accordingly the inflation of the airbag is not performed.

For example, JPH11-1153A (which will be hereinafter referred to as Patent reference 2) discloses a configuration in which an inflation pressure of an airbag apparatus is changed on the basis of a seat load detected by a load sensor. Thus, for example, in a case where an occupant seated at the seat is a physically small adult (a female and/or a child who does not need the child restraint seat, for example), the inflation pressure of the airbag apparatus is weakened so that a load given by the inflated airbag to the occupant can be reduced.

In a case where a physically large child is seated at the child restraint seat, however, there can be a case where the detection value of the seat load is substantially same as the detection value of a case where a physically small adult is seated at the seat. With the above-described known techniques, there is a problem that it is difficult to distinguish such cases from each other appropriately. Therefore, there remains room for improvement in this aspect.

A need thus exists for an occupant detection method and an occupant detection apparatus which are not susceptible to the drawback mentioned above.

### SUMMARY

According to an aspect of this disclosure, an occupant detection method includes detecting a load acting on a seat for a vehicle with use of a load sensor provided at the seat, monitoring a seating sensor output outputted from a seating sensor forming a detection region at the seat, and determining that a child occupant is seated at a child restraint seat installed at the seat when a detection value of the load sensor is equal to or larger than a minimum value determining that an adult occupant is seated at the seat and equal to or smaller than a maximum value determining that the child occupant is seated at the child restraint seat, in a case where the seating sensor output indicates a state in which a seating load of an occupant is not applied to the detection region, the seating load corresponding to a load of the occupant while the occupant is seated.

According to another aspect of this disclosure, an occupant detection method includes detecting a load acting on a seat for a vehicle with use of a load sensor provided at the seat, monitoring a seating sensor output outputted from a seating sensor forming a detection region at the seat, determining that an adult occupant is seated at the seat when a detection value of the load sensor is larger than a first threshold value, determining that the adult occupant is not seated at the seat when the detection value of the load sensor is smaller than a second threshold value that is set at a value smaller than the first threshold value, and determining that a child occupant is seated at a child restraint seat installed at the seat when the detection value of the load sensor is equal to or smaller than the first threshold value and equal to or larger than the second threshold value, in a case where the seating sensor output indicates a state in which a seating load of an occupant is not applied to the detection region, the seating load corresponding to a load of the occupant while the occupant is seated.

According to another aspect of this disclosure, an occupant detection apparatus includes a seat load detection portion detecting a load acting on a seat for a vehicle with use of a load sensor provided at the seat, a seating detection portion monitoring a seating sensor output outputted from a seating sensor forming a detection region at the seat, and a specific child seating determination portion determining that a child occupant is seated at a child restraint seat installed at the seat when a detection value of the load sensor is equal to or larger than a minimum value determining that an adult occupant is seated at the seat and equal to or smaller than a maximum value determining that the child occupant is seated at the child restraint seat, in a case where the seating sensor output indicates a state in which a seating load of an occupant is not applied to the detection region, the seating load corresponding to a load of the occupant while the occupant is seated.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration diagram (side view) of an occupant detection apparatus mounted on a seat for a vehicle according to an embodiment disclosed here;

FIG. 2 is a schematic configuration diagram (plan view) of the occupant detection apparatus mounted on the seat for the vehicle;

FIG. 3 is a cross-sectional view of a membrane switch forming a seating sensor according to the embodiment;

FIG. 4A is a diagram showing a minimum value determining that an adult occupant is seated at the seat according to the embodiment;

FIG. 4B a diagram showing a maximum value determining that a child occupant is seated at a child restraint seat installed on the seat according to the embodiment;

FIG. 5 is a flowchart showing procedures of an occupant detection determination according to the embodiment;

FIG. 6 is a flowchart showing procedures of changing control modes of an airbag according to the embodiment; and

FIG. 7 is a flowchart showing procedures of another example of the occupant detection determination.

### DETAILED DESCRIPTION

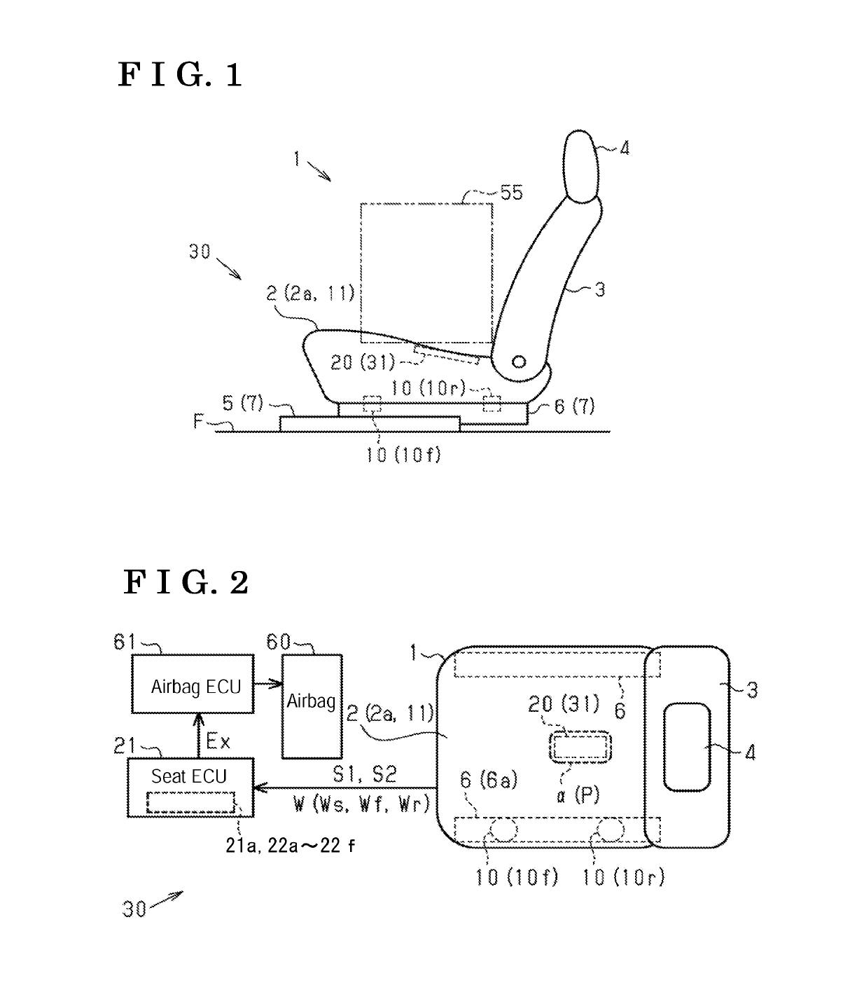

An embodiment of an occupant detection method and an occupant detection apparatus will be explained hereunder with reference to the drawings. As illustrated in FIG. 1, a seat 1 for a vehicle includes a seat cushion 2, and a seatback 3 provided at a rear end portion of the seat cushion 2 to be tiltable relative to the rear end portion of the seat cushion 2. A headrest 4 is provided at an upper end of the seatback 3.

In the embodiment, a pair of lower rails 5, 5 arranged at right and left, respectively, is provided at a floor portion F of the vehicle so as to extend in a vehicle front and rear direction. An upper rail 6 is attached to each lower rail 5 to be relatively movable on the lower rail 5 relative to the lower rail 5 in an extending direction thereof. The seat 1 of the embodiment is configured to be supported above a seat slide apparatus 7 formed by each of the lower rails 5 and the upper rails 6.

As illustrated in FIGS. 1 and 2, the seat 1 of the embodiment is provided with a load sensor 10 which detects a load Ws acting on the seat 1 (a detection value VV). The load Ws acting on the seat 1 corresponds to a seat load. The load sensor 10 is arranged below the seat cushion 2. In addition, the seat 1 is provided with a seating sensor 20 forming a detection region α at a seating surface 11 of the seat 1. Further, an output signal S1 of the load sensor 10 and an output signal S2 of the seating sensor 20 are inputted to a seat ECU 21. In the embodiment, an occupant detection apparatus 30 which performs occupant detection of the seat 1 is formed as described above.

In detail, a known strain sensor is used for the load sensor 10 of the embodiment. At the seat 1 of the embodiment, the load sensors 10 (10f, 10r) are provided between the upper rail 6 and the seat cushion 2 supported above the upper rail 6. More specifically, the load sensors 10 (10f, 10r) are provided at two positions in such a manner that the load sensor 10f is arranged in the vicinity of a front end portion of the upper rail 6a (6) positioned at a vehicle inner side of a seat width direction (at the lower side of FIG. 2) and the load sensor 10r is arranged in the vicinity of a rear end portion of the upper rail 6a positioned at the vehicle inner side of the seat width direction. Further, the seat ECU 21 serving as a seat load detection portion 22a allows a total value of a front load Wf of the seat 1 and a rear load Wr of the seat 1 to be the detection value W of the load sensor 10 (W=Ws=Wf+Wr). The front load Wf of the seat 1 is detected by the load sensor 10f arranged at the front side and the rear load Wr of the seat 1 is detected by the load sensor 10r arranged at the rear side. Thus, the occupant detection apparatus 30 serving as the seat load detection portion 22a is configured to enhance a detection accuracy of the load Ws acting on the seat 1.

At the seat 1 of the embodiment, a membrane switch 31 is provided at an inner side of the seat cushion 2. An on-state and an off-state of the membrane switch 31 are switched to each other as a seat facing 2a forming the seating surface 11 of the seat 1 is pressed or pushed. Further, the seat ECU 21 serving as a seating detection portion 22b monitors the on/off states of the membrane switch 31. Thus, the occupant detection apparatus 30 of the embodiment uses the membrane switch 31 as the seating sensor 20 which is a pressure-sensitive type.

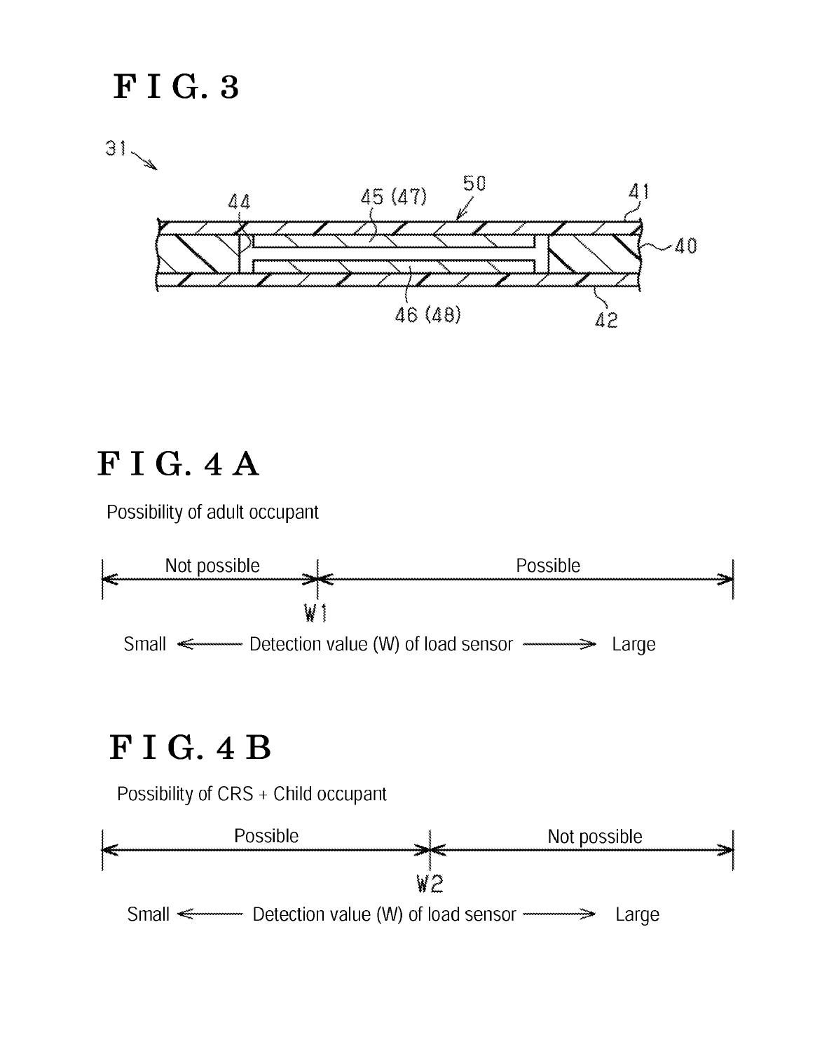

As illustrated in FIG. 3, the membrane switch 31 of the embodiment includes a known configuration in which a first film 41 and a second film 42 are laminated (stacked) each other with an intermediate film 40 serving as a spacer sandwiched between the first film 41 and the second film 42. Specifically, the first film 41 and the second film 42 are formed with circuit patterns 47 and 48, respectively. The circuit patterns 47 and 48 respectively include contact portions 45 and 46 which oppose each other via a communication portion (through hole) 44 formed at the intermediate film 40. In the embodiment, the circuit patterns 47 and 48 are formed by printing conductive ink, for example. The membrane switch 31 is arranged at the inner side of the seat cushion 2, more specifically, below or at a lower side relative to a cushion pad provided at an inner side of the seat facing 2a forming the seating surface 11, in a state where the first film 41 is positioned at the upper side.

That is, as the seat facing 2a arranged above the membrane switch 31 is pressed or pushed, the membrane switch 31 of the embodiment is elastically deformed in a manner that the first film 41 of the membrane switch 31 is deflected or bowed downward. Thus, the contact portion 45 formed at the first film 41 and the contact portion 46 formed at the second film 42 come to be in contact with each other. Accordingly, the membrane switch 31 is configured such that the contact portion 45 of the first film 41 and the contact portion 46 of the second film 42, which are arranged to face each other in an upper and lower direction, form a pressure-sensitive switch portion (cell) 50.

More specifically, according to the seat 1 of the embodiment, as illustrated in FIG. 2, the membrane switch 31 is provided under a regular seating position P set at the seating surface 11 of the seat 1, that is, under a position corresponding to a hip point of an adult occupant including a standard physical build in a case where the adult occupant is seated at the seat 1 in a state where a seating posture of the adult occupant does not include any deviation.

That is, according to the occupant detection apparatus 30 of the embodiment, the membrane switch 31 serving as the seating sensor 20 forms the detection region α at the regular seating position P set at the seating surface 11 of the seat 1. Then, it is determined whether or not a state in which a seating load of the occupant is applied to the detection region α is established, in accordance with whether or not the pressure-sensitive switch portion 50 is in a conduction state, that is, depending on whether the output signal S2 serving as a sensor output of the pressure-sensitive switch portion 50 is outputted as the on-state or as the off-state. The seating load of the occupant corresponds to a load of the occupant which is applied when the occupant is seated. That is, in a case where the output signal S2 is in the on-state, the seating sensor 20 indicates the state in which the seating load of the occupant is applied to the detection region α. In a case where the output signal S2 is in the off-state, the seating sensor 20 indicates a state in which the seating load of the occupant is not applied to the detection region α. In a case where a load, which is lower than the load of the occupant applied to the detection region α while the occupant is seated, acts on the detection region α, the seating sensor 20 indicates the state in which the seating load of the occupant is not applied to the detection region α. For example, in a case where the occupant performs an action of placing his or her hand in the detection region α, the seating sensor 20 indicates the state in which the seating load of the occupant is not applied to the detection region α.

Next, a manner of an occupant detection determination performed by the seat ECU 21 of the embodiment will be explained. As illustrated in FIGS. 4A and 4B, the seat ECU 21 holds or stores, in a memory area 21a (refer to FIG. 2), a minimum value (an adult determination minimum value W1) of the load Ws (the detection value VV) that determines that an adult occupant is seated at the seat 1 and a maximum value (a specific child determination maximum value W2) of the load Ws (the detection value W) that determines that a child occupant is seated at a child restraint seat 55 (that is, CRS) installed on the seat 1. By comparing the adult determination minimum value W1 and the specific child determination maximum value W2, with the detection value W detected by the load sensor 10, the occupant detection determination of the seat 1 is performed.

In detail, at the occupant detection apparatus 30 of the embodiment, the specific child determination maximum value W2 is set at a value that is larger than the adult determination minimum value W1. Consequently, in a case where the detection value W of the load sensor 10 is equal to or larger than the adult determination minimum value W1 and is equal to or smaller than the specific child determination maximum value W2 (W1≦W≦W2), a state in which it is determined that the adult occupant is seated at the seat 1 and a state in which the child occupant is seated at the child restraint seat 55 of the seat 1 are overlapped with each other.

In the above-described case, the seat ECU 21 of the embodiment determines whether or not the membrane switch 31 forming the seating sensor 20 is in the on-state. That is, the seat ECU 21 determines whether or not the sensor output (the output signal S2) of the seating sensor 20 indicates the state in which the seating load of the occupant is applied to the detection region α on the seating surface 11.

That is, many of child restraint seats (for example, the child restraint seat 55 installed on the seat 1) are installed on the seats in a state where a load is not applied to the regular seating position P set at the seating surface 11. It is rare that heavy baggage that is equivalent to a weight of an adult is loaded or placed on the seat 1 in a state where the load is not applied to the detection region α of the seating sensor 20.

Consequently, it is estimated that the occupant is directly seated relative to the seating surface 11 of the seat 1 in a case where the sensor output of the seating sensor 20 indicates the state in which the seating load of the occupant is applied to the detection region α. Thus, the occupant detection apparatus 30 of the embodiment appropriately determines the state in which the child occupant is seated at the child restraint seat 55 installed on the seat 1 distinctively from the state where the adult occupant is seated at the seat 1.

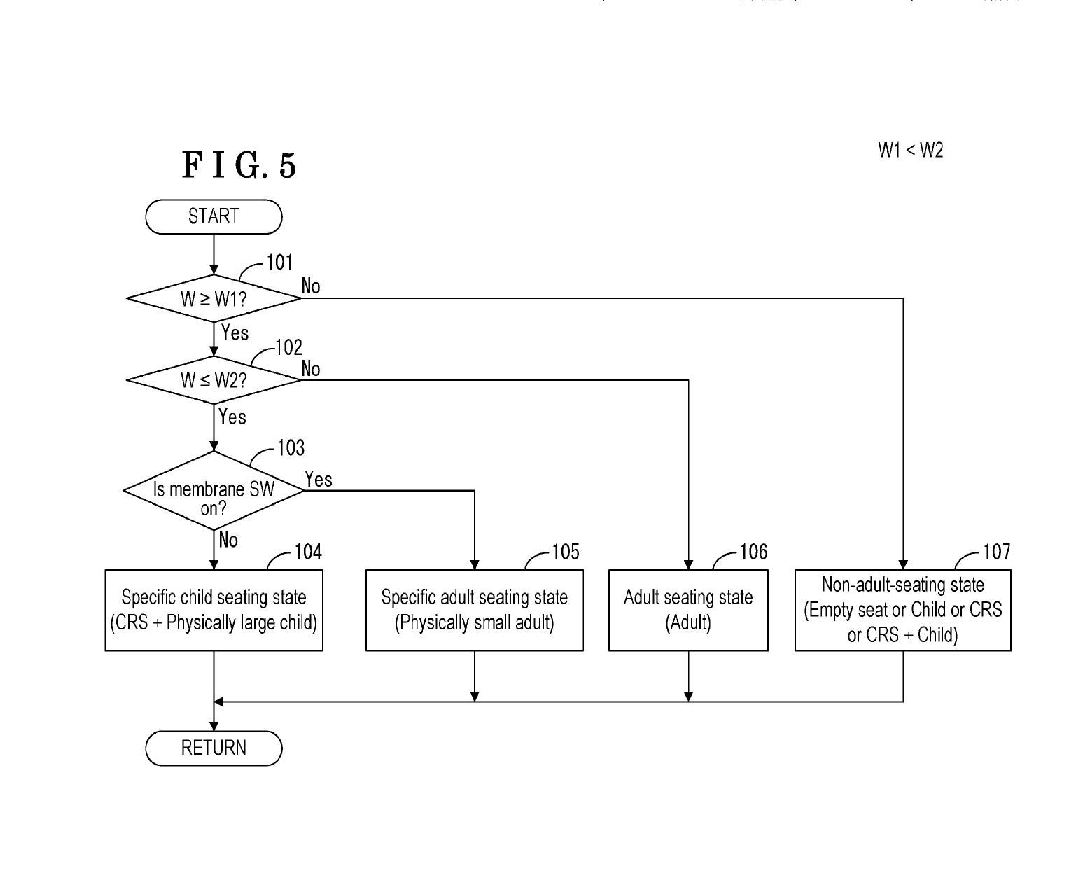

More specifically, as shown in the flowchart of FIG. 5, first, the seat ECU 21 of the embodiment determines whether or not the detection value W of the load sensor 10 is equal to or larger than the adult determination minimum value W1 (Step S101). In a case where the detection value W of the load sensor 10 is equal to or larger than the adult determination minimum value W1 (W≧W1, Step S101: YES), the seat ECU 21 subsequently determines whether or not the detection value W of the load sensor 10 is equal to or smaller than the specific child determination maximum value W2 (Step S102).

In a case where the seat ECU 21 determines that the detection value W of the load sensor 10 is equal to or smaller than the specific child determination maximum value W2 at Step S102 (W≦W2, Step S102: YES), the seat ECU 21 subsequently determines whether or not the membrane switch 31 forming the seating sensor 20 is in the on-state (Step S103). In a case where the membrane switch 31 is in the off-state (Step S103: NO), that is, in a case where a seating sensor output of the seating sensor 20 indicates the state in which the seating load of the occupant is not applied to the detection region α on the seating surface 11, the seat ECU 21 determines that the child occupant is seated at the child restraint seat 55 installed on the seat 1 (a specific child seating state, Step S104).

In addition, in this case, it can be estimated that the child occupant seated at the child restraint seat 55 is “a physically large child”. In a case where the membrane switch 31 is in the on-state at Step S103 (Step S103: YES), that is, in a case where the sensor output of the seating sensor 20 indicates the state in which the seating load of the occupant is applied to the detection region α, the seat ECU 21 determines that a physically small adult is seated at the seat 1 (a specific adult seating state, Step S105).

In a case where the seat ECU 21 serving as an adult seating determination portion 22e determines at Step S102 that the detection value W of the load sensor 10 is larger than the specific child determination maximum value W2 (W>W2, Step S102: NO), the seat ECU 21 determines that the adult occupant is seated at the seat 1 regardless of the on-state/off-state of the membrane switch 31 forming the seating sensor 20 (an adult seating state, Step S106). In a case where the detection value W of the load sensor 10 is smaller than the adult determination minimum value W1 at step S101 (W<W1, Step S101: NO), the seat ECU 21 serving as a non-adult-seating determination portion 22f determines that the adult occupant is not seated at the seat 1 regardless of the on-state/off-state of the membrane switch 31 (a non-adult-seating state, Step S107).

For example, in the embodiment, “the physically small adult” is assumed to include a female adult, and/or a child who, for example, is not required to be seated in the child restraint seat 55. “The non-adult-seating state” includes a case where the seat 1 is empty, a case where the child restraint seat 55 is installed on the seat 1, a case where a child (a regular child, that is, for example, a child who is required to be seated in a child restraint seat) is seated in the child restraint seat 55, or a case where a child (for example, a child who needs the child restraint seat 55) is seated in the seat 1 without using the child restraint seat 55.

Next, an inflation control of an airbag 60 on the vehicle on which the occupant detection apparatus 30 of the embodiment is mounted will be explained.

As illustrated in FIG. 2, the seat ECU 21 of the embodiment outputs the results of the above-described occupant detection determination, as an external output signal Ex, to an airbag ECU 61. On the vehicle on which the occupant detection apparatus 30 of the embodiment is mounted, the inflation control of the airbag 60 is performed on the basis of the results of the occupant detection determination performed by the seat ECU 21.

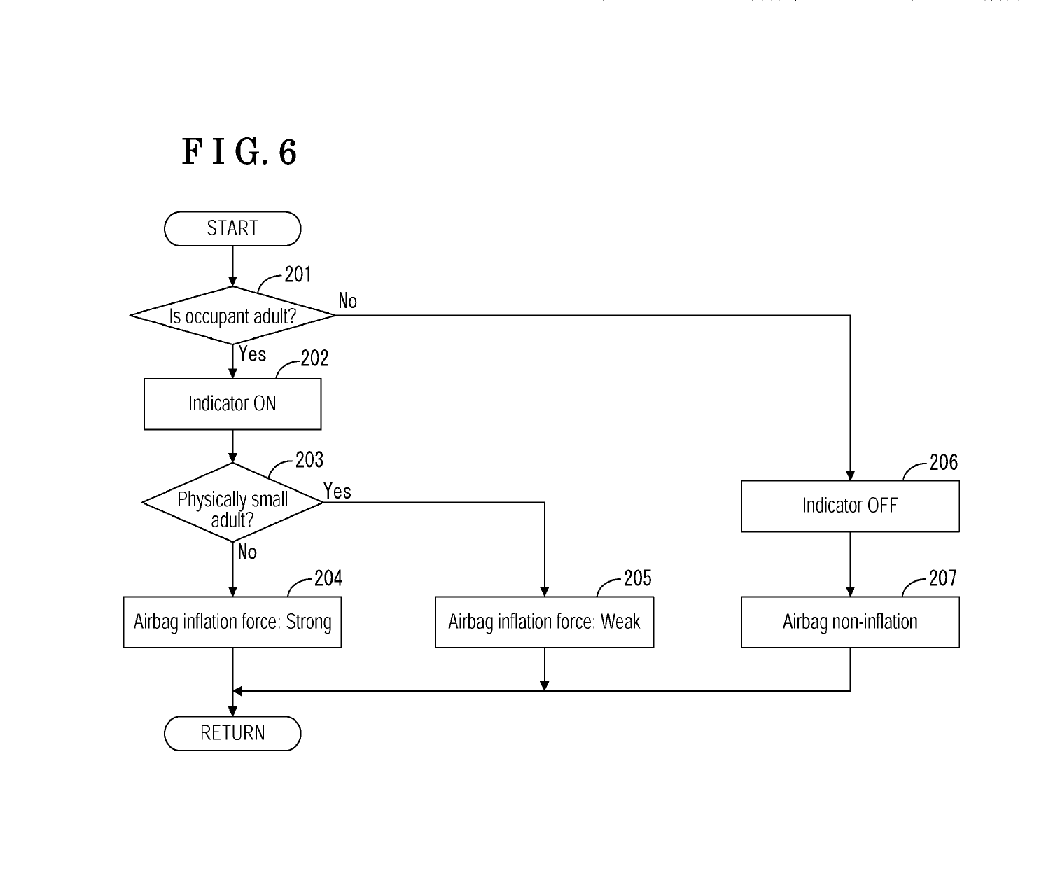

In detail, as shown in the flowchart of FIG. 6, first, the airbag ECU 61 of the embodiment determines whether or not the occupant seated at the seat 1 is the adult on the basis of the results of the occupant detection determination conducted by the seat ECU 21, the results which are received as the external output signal Ex (Step S201). In a case where the occupant of the seat 1 is the adult (Step S201: YES), the airbag ECU 61 activates or turns on an indicator (an on-operation of the indicator) indicating that the airbag 60 can be inflated relative to the occupant at the seat 1 (Step S202).

Next, the airbag ECU 61 of the embodiment determines whether or not the occupant at the seat 1 is the physically small adult (Step S203). In a case where the occupant at the seat 1 is not the physically small adult (Step S203: NO), the airbag ECU 61 sets a control mode of the airbag 60 at a first inflation mode including a predetermined inflation force (an inflation force: strong, Step S204). In a case where the occupant at the seat 1 is the physically small adult (Step S203: YES), the airbag ECU 61 sets the control mode of the airbag 60 at a second inflation mode including an inflation force which is weaker or smaller than the inflation force of the first inflation mode (the inflation force: weak, Step S205).

In a case where the airbag ECU 61 of the embodiment determines at Step S201 that the occupant at the seat 1 is not the adult (Step S201: NO), the airbag ECU 61 turns off (an off-operation of the indicator) the indicator (Step S206). Then, the airbag ECU 61 sets the control mode of the airbag 60 at a non-inflation mode in which the airbag 60 is not inflated (Step S207).

That is, in a case where it is determined that the occupant seated at the seat 1 is the physically small adult, the airbag ECU 61 of the embodiment conducts the inflation of the airbag 60 with the weakened or reduced inflation force. Thus, a load given by the inflated airbag 60 to the physically small adult is configured to be reduced while a collision safety performance being maintained high.

In a case where the occupant at the seat 1 is not the adult, that is, in a case of “the non-adult-seating state” or “the specific child seating state”, the airbag ECU 61 does not conduct the inflation of the airbag 60. Thus, it is configured such that the load due to the inflation of the airbag 60 is not given to the child occupant seated at the seat 1.

According to the embodiment, the following effects can be obtained. (1) The seat ECU 21 serving as a specific child seating determination portion 22c determines whether or not the detection value W of the load sensor 10 is equal to or larger than the minimum value (the adult determination minimum value W1) which determines that the adult occupant is seated at the seat 1. In addition, the seat ECU 21 determines whether or not the detection value W of the load sensor 10 is equal to or smaller than the maximum value (the specific child determination maximum value W2) which determines that the child occupant is seated at the child restraint seat 55 installed on the seat 1. Further, in a case where the detection value W of the load sensor 10 is equal to or larger than the adult determination minimum value W1 and is equal to or smaller than the specific child determination maximum value W2, the seat ECU 21 determines whether or not the membrane switch 31 forming the seating sensor 20 is in the on-state. In a case where the membrane switch 31 is in the off-state, that is, in a case where the state in which the seating load of the occupant is not applied to the detection region α of the seating surface 11 is indicated, the seat ECU 21 determines that the child occupant is seated at the child restraint seat 55 installed on the seat 1.

That is, many of the child restraint seats (for example, the child restraint seat 55) are installed on the seats (for example, the seat 1) in a state where the load is not applied to the detection region α of the seating sensor 20 which is formed at the seating surface 11. It is rare that the heavy baggage that is equivalent to a weight of an adult is loaded or placed on the seat 1 in a state where the load is not applied to the detection region α. Consequently, according to the above-described configuration, the state in which the child occupant is seated at the child restraint seat 55 installed on the seat 1 is appropriately differentiated from the state in which the adult occupant is seated at the seat 1. In addition, the embodiment is advantageous in that the seating sensor 20 may include a simple configuration that can determine whether or not the state in which the seating load of the occupant is applied to the detection region α on the seating surface 11 of the seat 1 is established.

(2) The seat ECU 21 serving as a specific adult seating determination portion 22d determines that the physically small adult occupant is seated at the seat 1 in a case where the detection value W of the load sensor 10 is equal to or larger than the adult determination minimum value W1 and equal to or smaller than the specific child determination maximum value W2, and the membrane switch 31 is in the on-state.

That is, in a case where the sensor output of the seating sensor 20 indicates the state in which the seating load of the occupant is applied to the detection region α, it is estimated that the occupant is seated directly on the seating surface 11 of the seat 1. At this time, in a case where the weight (the seating load) of the occupant which is indicated by the detection value W of the load sensor 10 does not deny that the adult occupant is seated, it can be determined that the occupant seated at the seat 1 is the physically small adult.

(3) The seat ECU 21 serving as the adult seating determination portion 22e determines that the adult occupant is seated at the seat 1 regardless of the seating sensor output of the seating sensor 20 in a case where the detection value W of the load sensor 10 is larger than the specific child determination maximum value W2 (W>W2).

That is, it is extremely rare that heavy baggage which is equivalent to the maximum value determining that the child occupant is seated at the child restraint seat 55 is placed on the seat 1. Consequently, according to the above-described configuration, it is determined, quickly or promptly with the simple configuration, that the adult occupant is seated at the seat 1.

(4) The seat ECU 21 serving as the non-adult-seating determination portion 22f determines that the adult occupant is not seated at the seat 1 regardless of the sensor output of the seating sensor 20 in a case where the detection value W of the load sensor 10 is smaller than the adult determination minimum value W1 (W<W1). Consequently, it is determined, quickly or promptly with the simple configuration, that the adult occupant is not seated at the seat 1.

(5) The seating sensor 20 forms the detection region α at the regular seating position P set at the seating surface 11. That is, in many cases, the child restraint seat 55 is installed on the seat 1 in a state where the load is not applied to the regular seating position P set at the seating surface 11. Consequently, by applying the above-described configuration, various types of child restraint seats are applicable. By forming the detection region α in a limited range, the seating sensor 20 can be simplified and downsized.

(6) The membrane switch 31, which is provided below the seat facing 2a forming the seating surface 11, is used as the seating sensor 20. Thus, the detection region α is formed at the seating surface 11 of the seat 1 and it is determined whether or not the state in which the seating load of the occupant is applied to the detection region α is established, with the simple configuration.

(7) In a case where it is determined that the occupant seated at the seat 1 is the physically small adult, the airbag ECU 61 causes the inflation force of the airbag 60 to be weakened and then causes the airbag 60 to inflate. In a case where the occupant seated at the seat 1 is not the adult, that is, in a case of “the non-adult-seating state” or “the specific child seating state”, the airbag ECU 61 does not perform the inflation of the airbag 60.

According to the above-described configuration, the collision safety performance is maintained high, and the load given by the inflated airbag 60 to the physically small adult occupant is reduced. The load due to the inflation of the airbag 60 is restricted from being applied to the child occupant seated at the seat 1.

The aforementioned embodiment may be changed or modified as follows. In the aforementioned embodiment, the load sensors 10 (10f, 10r) are provided at the two positions, that is, in the vicinity of each of the front and rear end portions of the upper rail 6a positioned at the vehicle inner side in the seat width direction. However, the disclosure is not limited thereto, and the arrangement and the number of the load sensor 10 may be changed arbitrarily. For example, the load sensor 10 may be arranged at a vehicle outer side of the seat width direction, or at both sides of the seat width direction. The load sensor 10 may be formed by a configuration other than the strain sensor.

For example, the shape and/or the number of the membrane switch 31 forming the seating sensor 20, and the number of cells may be changed arbitrarily. Further, the arrangement of the membrane switch 31 may be arbitrarily changed as long as the occupant seated at the seat 1 can be detected and the detection region α is formed at a position to which a load of the child restraint seat 55 installed on the seat 1 is not applied. In addition, the detection region α does not necessarily include the regular seating position P. A pressure sensor (which uses a strain sensor, for example) other than the membrane switch 31, or a proximity sensor (a capacitance sensor, for example) may be used to form the seating sensor 20 as long as the detection region α is formed at the seating surface 11 of the seat 1 and it can be determined whether or not the seating load of the occupant is in the state of being applied to the detection region α. In addition, when indicating that the seating sensor 20 is in the state where the seating load of the occupant when being seated is not applied to the detection region α, the determination does not need to be made on the basis that the output signal S2 of the single pressure-sensitive switch portion 50 is in the off-state. For example, the membrane switch 31 may include plural pressure-sensitive switch portions 50. In a case where the number of the pressure-sensitive switch portions 50 whose conductive states are in the on-states is smaller than a predetermined threshold value, it may be indicated that the state in which the seating load of the occupant is not applied to the detection region α is established. Further, when indicating that the seating sensor 20 is in the state where the seating load of the occupant is applied to the detection region α, the determination does not need to be made on the basis that the output signal S2 of the pressure-sensitive switch portion 50 is in the on-state. That is, the membrane switch 31 may include plural pressure-sensitive switch portions 50, and it may be indicated that the seating sensor 20 is in the state where the seating load of the occupant is applied to the detection region α in a case where the number of the pressure-sensitive switch portions 50 whose conductive states are in the on-states is equal to or larger a predetermined threshold value. In addition, for example, in a case where the seating sensor 20 is a capacitance sensor and the output signal S2 from the seating sensor 20 is indicated with a numerical value, it can be indicated that the seating sensor 20 is in the state where the seating load of the occupant is applied to the detection region α or in the state where the seating load of the occupant is not applied to the detection region α, on the basis of a magnitude relationship of the output signal S2 relative to a predetermined threshold value. In addition, the seating sensor 20 does not need to be arranged at the seating surface 11 of the seat 1. For example, the seating sensor 20 may be provided at the seatback 3 of the seat 1.

In the aforementioned embodiment, the airbag ECU 61 does not conduct the inflation of the airbag 60 in a case where the occupant at the seat 1 is not the adult, that is, in a case of “the non-adult-seating state” or “the specific child seating state”. In a case where it is determined that the occupant seated at the seat 1 is the physically small adult, the inflation force of the airbag 60 is weakened and the inflation of the airbag 60 is performed. However, the content of the inflation control of the airbag 60 on the basis of the result of the occupant detection determination may be changed arbitrarily.

For example, in a case where the airbag 60 does not include an inflation pressure adjustment function, the inflation of the airbag 60 may be allowed in a case where the occupant is the adult, regardless of the physical build of the occupant. In a case where the inflation pressure of the airbag 60 is adjustable in a multistep manner, the airbag 60 may be allowed, in accordance with requirements of the laws, to inflate with the weakened inflation force even though it is detected that the child occupant is seated at the child restraint seat 55 installed on the seat 1, for example.

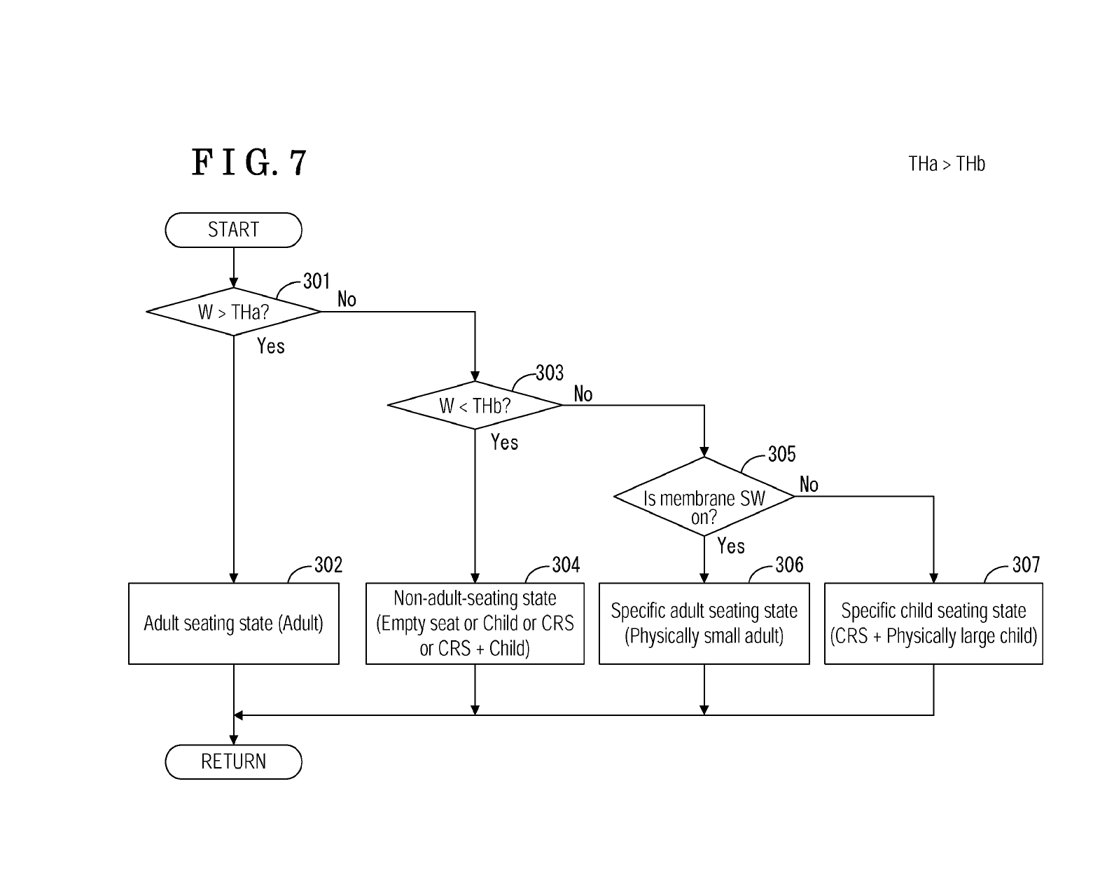

As illustrated in the flowchart of FIG. 7, in a case where the detection value W of the load sensor 10 is larger than a first threshold value THa (W>THa, Step S301: YES), it is determined that the adult occupant is seated at the seat 1 (the adult seating state, Step S302). In a case where the detection value W of the load sensor 10 is smaller than a second threshold value THb (W<THb, Step S303: YES), it is determined that the adult occupant is not seated at the seat 1 (the non-adult-seating state, Step S304). The second threshold value is set at a value smaller or lower than the first threshold value THa. In a case where the detection value W of the load sensor 10 is equal to or smaller than the first threshold value THa and equal to or larger than the second threshold value THb (THb≦W≦THa, Step S303: NO), it is determined whether the membrane switch 31 is in the on-state, that is, whether or not the state is established in which the seating load of the occupant is applied to the detection region α on the seating surface 11 (Step S305). In a case where the membrane switch 31 is in the off-state (Step S305: NO), it is determined that the child occupant is seated at the child restraint seat 55 installed on the seat 1 (the specific child seating state, Step S307).

Also in this case, in a case where the detection value W of the load sensor 10 is equal to or smaller than the first threshold value THa and equal to or larger than the second threshold value THb (Step S303: NO) and the membrane switch 31 is in the on-state (Step S305: YES), it is determined that the physically small adult occupant is seated at the seat 1 (the specific adult seating state, Step S306). With the above-described configuration, the similar effects to the aforementioned embodiment can be obtained.

That is, the specific child determination maximum value W2 of the aforementioned embodiment serves as the above-described first threshold value THa and the adult determination minimum value W1 of the aforementioned embodiment serves as the above-described second threshold value THb. Thus, the state where the adult occupant is seated at the seat 1 (the adult seating state) and the state where the adult occupant is not seated at the seat 1 (the non-adult-seating state) are determined distinctively from each other so as not to be overlapped with each other. In a case where neither of the above-described two states applies, it is confirmed that the state in which the seating load of the occupant is not applied to the detection region α formed at the seating surface 11 by the seating sensor 20 is established, that is, it is confirmed that the state in which the occupant is seated directly at the seat 1 is not established. Accordingly, it is determined appropriately that the child occupant is seated at the child restraint seat installed on the seat 1.

Next, technical ideas which can be grasped from the aforementioned embodiment will be described together with effects thereof. (A) The seating sensor forms the detection region at the regular seating position which is set at the seating surface. Many of the child restraint seats, that is, many types of the child restraint seats, are installed on the seats in a state where the load is not applied to the regular seating position set at the seating surface. Consequently, by applying the above-described configuration, various types of child restraint seats are applicable. By forming the detection region in the limited range, the seating sensor can be simplified and downsized.

(B) The seating sensor corresponds to the membrane switch provided below the seat facing forming the seating surface. Consequently, with the simple configuration, the detection region can be formed at the seating surface of the seat and it can be determined whether or not the state in which the seating load of the occupant is applied to the detection region is established.

(C) The occupant detection method includes detecting the load acting on the seat for the vehicle with the use of the load sensor provided at the seat, monitoring the seating sensor output outputted from the seating sensor forming the detection region of the seat, determining that the adult occupant is seated at the seat when the detection value of the load sensor is larger than the first threshold value, determining that the adult occupant is not seated at the seat when the detection value of the load sensor is smaller than the second threshold value that is set at the value lower than the first threshold value, and determining that the child occupant is seated at the child restraint seat installed at the seat when the detection value of the load sensor is equal to or smaller than the first threshold value and equal to or larger than the second threshold value and the seating sensor output indicates the state in which the load of the occupant is not applied to the detection region.

(D) The occupant detection method includes determining that the physically small adult occupant is seated at the seat when the detection value of the load sensor is equal to or smaller than the first threshold value and equal to or larger than the second threshold value, in a case where the seating sensor output indicates the state in which the load of the occupant is applied to the detection region.

According to the aforementioned embodiment, the occupant detection method includes detecting the load W acting on the seat 1 for the vehicle with the use of the load sensor 10 provided at the seat 1, monitoring the seating sensor output outputted from the seating sensor 20 forming the detection region α at the seat 1, and determining that the child occupant is seated at the child restraint seat 55 installed at the seat 1 when the detection value W of the load sensor 10 is equal to or larger than the minimum value W1 determining that the adult occupant is seated at the seat 1 and equal to or smaller than the maximum value W2 determining that the child occupant is seated at the child restraint seat 55, in a case where the seating sensor output indicates the state in which the seating load of the occupant is not applied to the detection region α. The seating load corresponds to the load of the occupant while the occupant is seated.

Many of the child restraint seats (for example, the child restraint seat 55 installed on the seat 1) are installed on the seats in a state where the load is not applied to the detection region a of the seating sensor 20, the detection region α which is provided at the seat 1. It is rare that the heavy baggage of which the weight is equivalent to the weight of the adult is placed on the seat 1 in a state where the load of the baggage is not applied to the detection region α. Consequently, according to the above-described configuration, it is appropriately determined that the child occupant is seated at the child restraint seat 55 installed on the seat 1. In addition, the aforementioned embodiment is advantageous in that the seating sensor 20 may include the simple configuration as long as the seating sensor 20 is capable of determining whether or not the state in which the seating load of the occupant is applied to the seat 1 is established.

According to the aforementioned embodiment, it is determined appropriately that the child occupant is seated at the child restraint seat installed on the seat.

According to the aforementioned embodiment, the occupant detection method includes determining that the physically small adult occupant is seated at the seat 1 when the detection value W of the load sensor 10 is equal to or larger than the minimum value W1 determining that the adult occupant is seated at the seat 1 and equal to or smaller than the maximum value W2 determining that the child occupant is seated at the child restraint seat 55, in a case where the seating sensor output indicates a state in which the seating load of the occupant is applied to the detection region α.

That is, in a case where the sensor output of the seating sensor 20 indicates the state in which the seating load of the occupant is applied to the detection region α, it is estimated that the occupant is seated directly at the seat 1. At this time, in a case where the weight (the seating load) of the occupant which is indicated by the detection value W of the load sensor 10 does not deny that the occupant is the adult, it can be determined that the occupant seated at the seat 1 is the physically small adult.

According to the aforementioned embodiment, the occupant detection method includes determining that the adult occupant is seated at the seat 1 regardless of the seating sensor output when the detection value W of the load sensor 10 is larger than the maximum value W2 determining that the child occupant is seated at the child restraint seat 55.

That is, it is extremely rare that baggage which is heavier than the maximum value determining that the child occupant is seated at the child restraint seat 55 is placed on the seat 1. Consequently, according to the above-described configuration, it is determined, quickly or promptly with the simple configuration, that the adult occupant is seated at the seat 1.

According to the aforementioned embodiment, the occupant detection method includes determining that the adult occupant is not seated at the seat 1 regardless of the seating sensor output when the detection value W of the load sensor 10 is smaller than the minimum value W1 determining that the adult occupant is seated at the seat 1.

According to the aforementioned embodiment, it is determined, quickly or promptly with the simple configuration, that the adult occupant is not seated at the seat 1.

According to the aforementioned embodiment, the seating sensor 20 is provided at the seating surface 11 of the seat 1.

According to the aforementioned embodiment, the seating sensor 20 forms the detection region α at the seating position P which is set at the seating surface 11 of the seat 1 and at which the adult occupant is seated without being deviated.

In many cases, the child restraint seat (including, for example, the child restraint seat 55 installed on the seat 1) is installed on the seat in a state where the load is not applied to the regular seating position P set at the seating surface 11. Consequently, by applying the above-described configuration, various types of child restraint seats 55 are applicable. By forming the detection region α in a limited range, the seating sensor 20 can be simplified and downsized.

According to the aforementioned embodiment, the seating sensor 20 corresponds to the membrane switch 31 provided below the seat facing 2a forming the seating surface 11 of the seat 1.

According to the above-described configuration, with the simple configuration, the detection region α can be formed at the seating surface 11 of the seat 1 and it can be determined whether or not the state, in which the seating load of the occupant is applied to the detection region, is established.

According to the aforementioned embodiment, the occupant detection method includes detecting the load acting on the seat 1 for the vehicle with the use of the load sensor 10 provided at the seat 1, monitoring the seating sensor output outputted from the seating sensor 20 forming the detection region α at the seat 1, determining that the adult occupant is seated at the seat 1 when the detection value W of the load sensor 10 is larger than the first threshold value THa, determining that the adult occupant is not seated at the seat 1 when the detection value W of the load sensor 10 is smaller than the second threshold value THb that is set at a value smaller than the first threshold value THa, and determining that the child occupant is seated at the child restraint seat 55 installed at the seat 1 when the detection value W of the load sensor 10 is equal to or smaller than the first threshold value THa and equal to or larger than the second threshold value THb, in a case where the seating sensor output indicates the state in which the seating load of the occupant is not applied to the detection region α, the seating load corresponding to the load of the occupant while the occupant is seated.

Many of the child restraint seats (for example, the child restraint seat 55 installed on the seat 1) are installed on the seats in a state where the load is not applied to the detection region a of the seating sensor 20, the detection region α which is provided at the seat 1. It is rare that the heavy baggage of which the weight is equivalent to the weight of the adult is placed on the seat 1 in a state where the load of the baggage is not applied to the detection region α. Consequently, according to the above-described configuration, it is appropriately determined that the child occupant is seated at the child restraint seat 55 installed on the seat 1. In addition, the aforementioned embodiment is advantageous in that the seating sensor 20 may include the simple configuration as long as the seating sensor 20 is capable of determining whether or not the state in which the seating load of the occupant is applied to the seat 1 is established.

According to the aforementioned embodiment, the occupant detection method includes determining that the adult occupant is seated at the seat 1 when the detection value W of the load sensor 10 is equal to or smaller than the first threshold value THa and equal to or larger than the second threshold value THb, in a case where the seating sensor output indicates the state in which the load of the occupant is applied to the detection region α.

According to the aforementioned embodiment, the occupant detection apparatus 30 includes the seat load detection portion 22a detecting the load acting on the seat 1 for the vehicle with the use of the load sensor 10 provided at the seat 1, the seating detection portion 22b monitoring the seating sensor output outputted from the seating sensor 20 forming the detection region α at the seat 1, and the specific child seating determination portion 22c determining that the child occupant is seated at the child restraint seat 55 installed at the seat 1 when the detection value W of the load sensor 10 is equal to or larger than the minimum value W1 determining that the adult occupant is seated at the seat 1 and equal to or smaller than the maximum value W2 determining that the child occupant is seated at the child restraint seat 55, in a case where the seating sensor output indicates the state in which the seating load of the occupant is not applied to the detection region α. The seating load corresponds to the load of the occupant while the occupant is seated.

According to the aforementioned embodiment, the occupant detection apparatus 30 includes the specific adult seating determination portion 22d determining that the physically small adult is seated at the seat 1 when the detection value W of the load sensor 10 is equal to or larger than the minimum value W1 determining that the adult occupant is seated at the seat 1 and equal to or smaller than the maximum value W2 determining that the child occupant is seated at the child restraint seat 55, in a case where the seating sensor output indicates the state in which the seating load of the occupant is applied to the detection region α.

According to the aforementioned embodiment, the occupant detection apparatus 30 includes the adult seating determination portion 22e determining that the adult occupant is seated at the seat 1 regardless of the seating sensor output when the detection value W of the load sensor 10 is larger than the maximum value W2 determining that the child occupant is seated at the child restraint seat 55.

According to the aforementioned embodiment, the occupant detection apparatus 30 includes the non-adult-seating determination portion 22f determining that the adult occupant is not seated at the seat 1 regardless of the seating sensor output when the detection value W of the load sensor 10 is smaller than the minimum value W1 determining that the adult occupant is seated at the seat 1.

According to the aforementioned embodiment, the seating sensor 20 is provided at a seating surface 11 of the seat 1.

According to the aforementioned embodiment, the seating sensor 20 forms the detection region α at the seating position P which is set at the seating surface (11) and at which the adult occupant is seated without being deviated.

According to the aforementioned embodiment, the seating sensor 20 corresponds to the membrane switch 31 provided below the seat facing 2a forming the seating surface 11.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An occupant detection method comprising:
detecting a load acting on a seat for a vehicle with use of a load sensor provided at the seat;
monitoring a seating sensor output outputted from a seating sensor forming a detection region at the seat; and
determining that a child occupant is seated at a child restraint seat installed at the seat when a detection value of the load sensor is equal to or larger than a minimum value determining that an adult occupant is seated at the seat and equal to or smaller than a maximum value determining that the child occupant is seated at the child restraint seat, in a case where the seating sensor output indicates a state in which a seating load of an occupant is not applied to the detection region, the seating load corresponding to a load of the occupant while the occupant is seated.

2. The occupant detection method according to claim 1, comprising:
determining that a physically small adult occupant is seated at the seat when the detection value of the load sensor is equal to or larger than the minimum value determining that the adult occupant is seated at the seat and equal to or smaller than the maximum value determining that the child occupant is seated at the child restraint seat, in a case where the seating sensor output indicates a state in which the seating load of the occupant is applied to the detection region.

3. The occupant detection method according to claim 1, comprising:
determining that the adult occupant is seated at the seat regardless of the seating sensor output when the detection value of the load sensor is larger than the maximum value determining that the child occupant is seated at the child restraint seat.

4. The occupant detection method according to claim 1, comprising:
determining that the adult occupant is not seated at the seat regardless of the seating sensor output when the detection value of the load sensor is smaller than the minimum value determining that the adult occupant is seated at the seat.

5. The occupant detection method according to claim 1, wherein the seating sensor is provided at a seating surface of the seat.

6. The occupant detection method according to claim 1, wherein the seating sensor forms the detection region at a seating position which is set at a seating surface of the seat and at which the adult occupant is seated without being deviated.

7. The occupant detection method according to claim 1, wherein the seating sensor corresponds to a membrane switch provided below a seat facing forming a seating surface of the seat.

8. An occupant detection method comprising:
detecting a load acting on a seat for a vehicle with use of a load sensor provided at the seat;
monitoring a seating sensor output outputted from a seating sensor forming a detection region at the seat;
determining that an adult occupant is seated at the seat when a detection value of the load sensor is larger than a first threshold value;
determining that the adult occupant is not seated at the seat when the detection value of the load sensor is smaller than a second threshold value that is set at a value smaller than the first threshold value; and
determining that a child occupant is seated at a child restraint seat installed at the seat when the detection value of the load sensor is equal to or smaller than the first threshold value and equal to or larger than the second threshold value, in a case where the seating sensor output indicates a state in which a seating load of an occupant is not applied to the detection region, the seating load corresponding to a load of the occupant while the occupant is seated.

9. The occupant detection method according to claim 8, comprising:
determining that the adult occupant is seated at the seat when the detection value of the load sensor is equal to or smaller than the first threshold value and equal to or larger than the second threshold value, in a case where the seating sensor output indicates a state in which the load of the occupant is applied to the detection region.

10. An occupant detection apparatus comprising:
a seat load detection portion detecting a load acting on a seat for a vehicle with use of a load sensor provided at the seat;
a seating detection portion monitoring a seating sensor output outputted from a seating sensor forming a detection region at the seat; and
a specific child seating determination portion determining that a child occupant is seated at a child restraint seat installed at the seat when a detection value of the load sensor is equal to or larger than a minimum value determining that an adult occupant is seated at the seat and equal to or smaller than a maximum value determining that the child occupant is seated at the child restraint seat, in a case where the seating sensor output indicates a state in which a seating load of an occupant is not applied to the detection region, the seating load corresponding to a load of the occupant while the occupant is seated.

11. The occupant detection apparatus according to claim 10, comprising:
a specific adult seating determination portion determining that a physically small adult is seated at the seat when the detection value of the load sensor is equal to or larger than the minimum value determining that the adult occupant is seated at the seat and equal to or smaller than the maximum value determining that the child occupant is seated at the child restraint seat, in a case where the seating sensor output indicates a state in which the seating load of the occupant is applied to the detection region.

12. The occupant detection apparatus according to claim 10, comprising:
an adult seating determination portion determining that the adult occupant is seated at the seat regardless of the seating sensor output when the detection value of the load sensor is larger than the maximum value determining that the child occupant is seated at the child restraint seat.

13. The occupant detection apparatus according to claim 10, comprising:
a non-adult-seating determination portion determining that the adult occupant is not seated at the seat regardless of the seating sensor output when the detection value of the load sensor is smaller than the minimum value determining that the adult occupant is seated at the seat.

14. The occupant detection apparatus according to claim 10, wherein the seating sensor is provided at a seating surface of the seat.

15. The occupant detection apparatus according to claim 14, wherein the seating sensor forms the detection region at a seating position which is set at the seating surface and at which the adult occupant is seated without being deviated.

16. The occupant detection apparatus according to claim 14, wherein the seating sensor corresponds to a membrane switch provided below a seat facing forming the seating surface.
